(19) United States
(12) Patent Application Publication
(10) Pub. No.: US 2017/0048582 A1
(43) Pub. Date: Feb. 16, 2017

(54) DISPLAY CONTROL SYSTEM, METHOD FOR DISPLAY CONTROL AND DISPLAY DEVICE

(71) Applicant: BOE TECHNOLOGY GROUP CO., LTD., Beijing (CN)

(72) Inventors: Xiao Zhang, Beijing (CN); Fan Yang, Beijing (CN)

(21) Appl. No.: 15/161,623

(22) Filed: May 23, 2016

(30) Foreign Application Priority Data
Aug. 11, 2015 (CN) 201510490627.4

(51) Int. Cl. H04N 21/442; G06F 3/01; H04N 21/443; H04N 21/45; H04N 21/439; H04N 5/57; G06F 3/16; G06K 9/00

(52) U.S. Cl. CPC H04N 21/44218; G06F 3/165; G06F 3/012; G06K 9/00255; H04N 21/4532; H04N 21/439; H04N 5/57; H04N 21/4436

(57) ABSTRACT

A display control system and a method, and a display device, the above system comprising: an acquisition module configured to collect information of users within a target region, verify user identity according to said information, and also to detect whether exists a user viewing the display within said target region; a query module configured to query corresponding information about view habit according to the user identity; a control module configured to adjust an image output and/or an audio output of said display according to said information about view habit in a case where exists no user viewing the display within said target region. By the present technical solution, it is possible to control the display according to the user of different identities in a case where exists no user viewing the display within the target region.

### TECHNICAL FIELD

The present application relates to the display technical field, and in particular to a display control system, a method for display control and a display device.

### BACKGROUND

Among the existing television energy-saving techniques, the technical solution adopted mainly functions by automatic determining whether a viewer exists so as to determine whether the TV should be shut off to achieve the role of energy saving.

The drawback of the above method lies in the absence of realizing that different viewers may have different needs with respect to TV energy saving. For example, to avoid the trouble due to power on and off, the old may not choose to shut off the TV when leaving, under such circumstance, to shut off the TV in order for energy saving will necessarily reduce the user experience.

### SUMMARY

A technical problem to be solved by the present invention is to adjust a display output manner according to different user habit.

For this purpose, the present invention provides a display control system, comprising:

an acquisition module configured to collect information of users within a target region, verify user identity according to said information, and also to detect whether exists a user viewing the display within said target region;

a query module configured to query corresponding information about view habit according to the user identity;

a control module configured to adjust an image output and/or an audio output of said display according to said information about view habit in a case where exists no user viewing the display within said target region.

For example, said information about view habit comprises a preset departure time and a preset play manner, and said control module comprises:

a timing unit configured to record a duration time during which exists no user viewing the display within the target region;

an adjusting unit configured to adjust the image output and/or the audio output of said display according to said preset play manner in a case where said duration time is longer than said preset departure time.

For example, after said control module adjusts the image output and/or the audio output of said display, when said acquisition module detects there exists user viewing the display in said target region, said adjusting unit further configured to recover the image output and/or the audio output of said display to the status before adjustment.

For example, when said acquisition module detects there exists user viewing the display in said target region, and when the current user is consistent to the one before adjustment, the image output and/or the audio output of said display is adjusted back to the status before adjustment.

For example, it further comprises:

a recognition module configured to recognize a type of a play program of said display,

wherein, said adjusting unit is configured to adjust the image output and/or the audio output of said display according to said information about view habit and said type of the play program.

For example, when said acquisition module collects the information of a plurality of users within said target regions, a plurality of user identities are verified according to the information of said plurality of users, and a user identity of the highest priority is determined among the information of said plurality of users;

said query module is to query the information about view habit of the corresponding highest priority according to said user identity of the highest priority;

said control module is to adjust the image output and/or the audio output of said display according to the information about view habit of the highest priority.

For example, said acquisition unit is configured to determine whether there exists a user in said target region,

if no user exists, it determines there exists no user viewing the display in said target region,

if a user exists, it decides whether the face of the user is towards the display, if the face of the user is not towards the display, it determines there exists no user viewing the display in said target region, if the face of the user is towards the display, it determines there exists user viewing the display in said target region.

For example, said control module is to adjust the image output and/or the audio output of said display comprising: at least one of closing the image output, closing the audio output, reducing an image luminance, and reducing an audio volume.

For example, it further comprises: a setting module configured to set the information about view habit according to the received instruction;

A statistic module configured to calculate the duration time in which the user does not view the display each time and the type of program viewed by the user and adjust corresponding information about view habit according to a statistic result.

The present invention further provides a display device, comprising the display control system of any of the above items.

The present invention further provides a method for display control, comprising:

collecting information of users within a target region, verifying a user identity according to said information, detecting whether or not there exists a user viewing the display within said target region;

querying corresponding information about view habit according to the user identity;

adjusting an image output and/or an audio output of said display according to said information about view habit in a case where exists no user viewing the display within said target region.

For example, said information about view habit comprises a preset departure time and a preset play manner, and adjusting an image output and/or an audio output of said display according to said information about view habit comprises:

recording a duration time during which there exists no user viewing the display within the target region;

adjusting the image output and/or the audio output of said display according to said preset play manner in a case where said duration time is longer than said preset departure time.

For example, after adjusting the image output and/or the audio output of said display, when it is detected that there exists user viewing the display in said target region, recovering the image output and/or the audio output of said display to the status before adjustment.

For example, when it is detected that there exists user viewing the display in said target region, and when the current user is consistent to the one before adjustment, adjusting the image output and/or the audio output of said display back to the status before adjustment.

For example, it further comprises: recognizing the type of the play program of said display, and adjusting the image output and/or the audio output of said display according to said information about view habit comprises:

Adjusting the image output and/or the audio output of said display according to said information about view habit and said type of the play program.

For example, when said acquisition module collects the information of a plurality of users within said target regions, verifying a plurality of user identities according to said information comprises:

verifying the plurality of user identities according to the information of said plurality of users, determining a user identity of the highest priority among the information of said plurality of users;

querying the information about view habit of the corresponding highest priority according to said user identity of the highest priority by said query module;

adjusting the image output and/or the audio output of said display according to the information about view habit of the highest priority by said control module.

For example, detecting whether there exists a user viewing the display in said target region comprises:

determining whether there exists a user in said target region;

if no user exists, it decides there exists no user viewing the display in said target region,

if a user exists, it determines whether the face of the user is towards the display, if the face of the user is not towards the display, it determines there exists no user viewing the display in said target region, if the face of the user is towards the display, it determines there exists user viewing the display in said target region.

For example, adjusting the image output and/or the audio output of said display comprising: at least one of closing the image output, closing the audio output, reducing an image luminance, and reducing an audio volume.

For example, it further comprises:

Setting the information about view habit according to an received instruction;

calculating a duration time in which the user does not view the display each time and the type of program viewed by the user and adjusting corresponding information about view habit according to a statistic result.

By the above technical solution, it is possible to control the display with only the audio and image output, or only adjusts the audio output, or both adjusts the image output and the audio output according to the user of different identities in a case where exists no user viewing the display within the target region, as compared to stop outputting image once no user is detected viewing the display in the prior art, the present invention not only can reduce the power consumption of the display but also adapt the control of the display to the view habit of the user, and advantageously ensure the view experience of the user.

### BRIEF DESCRIPTION OF THE DRAWINGS

The features and advantages of the present invention will be understood more clearly with reference to the drawings, which is illustrative and should not be understood as any limitation to the present invention, in which:

FIG. 1 shows a schematic block view of the display control system according to an embodiment of the present invention.

FIG. 2 shows a schematic flowchart of the display control system according to an embodiment of the present invention.

FIG. 3 shows a schematic flowchart for determining whether there exists a user viewing the display within the target region according to an embodiment of the present invention.

### DETAILED DESCRIPTION OF THE EMBODIMENTS

In order to more clearly understand the above objects, features and advantages of the present invention, hereinafter, a detailed description will further be made to the present invention in combination to the accompanying drawings and the following specific embodiments. It is noted that, in the case of no conflict, embodiments and features in the examples of the present application may be combined with each other.

In the following description, numerous specific details are set forth in order to fully understand the present invention, however, the present invention can also be used in other ways different from those described herein, therefore, the scope of the present invention is not limited to the examples specifically disclosed below.

As shown in FIG. 1, a display control system 10 according to an embodiment of the present invention, comprises:

an acquisition module 11 configured to collect information of users within a target region, verifying user identity according to said information, and also to detect whether exists a user viewing the display within said target region;

a query module 12 configured to query corresponding information about view habit according to the user identity;

a control module 13 configured to adjust an image output and/or audio output of said display according to said information about view habit in a case where exists no user viewing the display within said target region.

The present embodiment allows to control the display with only the audio and image output, or only adjusts the audio output, or both adjusts the image output and the audio output according to the user of different identities in a case where exists no user viewing the display within the target region, as compared to stop outputting image once no user is detected viewing the display in the prior art, the present invention not only can reduce the power consumption of the display but also adapt the control of the display to the view habit of the user, and advantageously ensure the view experience of the user.

It is noticed that in a case where exists no user viewing the display within the target region, not only comprises a case where no user exists in the target region, but also a case where a user exists in the target region while the face of the user is not towards to the display.

For example, when a user is viewing the display, since he should leave the target region in front of the display for housework, cooking for a period, meanwhile he would like to listen to the content played in the display when doing other things. The information about view habit may be set so that it is illustrated a user is viewing the display when the acquisition module 11 verified the user's identity, and the display is controlled to stop image output while maintaining audio output when said user leaves the target region, such that on one hand, saving the energy required for image display, and on the other hand ensuring the user to continue listening to the content played by the display and thus ensuring user experience.

Further as an example, when a child, especially a kid plays a children program by a display, it is required to keep the TV on even if he is not in front of the TV, otherwise, he will cry and thus bring troubles to parents. The information about view habit of that child may be preset to reduce an luminance of the output image and reduce an volume of the output audio when leaving the target region, it is illustrated that the child is viewing the display when the acquisition module 11 verified the child's identity, and the display is controlled to reduce an luminance of the output image and reduce an volume of the output audio when said child leaves the target region, or his face is not towards the display, such that on one hand, saving the energy, and on the other hand ensuring the child will not cry.

Further as an example, to avoid troubles about TV on and off, the old will not choose to shut off the TV when leaving the target region. The information about view habit of the old may be preset to be no adjustment to the display when leaving the target region. When the acquisition module 11 verified the old's identity, it is illustrated that the old is viewing the display, when there exists no user viewing the display, no adjustment is conducted to the display to ensure the display is still at normal output status when the old is back.

For example, information about view habit comprises a preset departure time and a preset play manner, and said control module 13 comprises:

a timing unit 131 configured to record a duration time in which exists no user viewing the display within the target region;

an adjusting unit 132 configured to adjust the image output and/or the audio output of said display according to said preset play manner in a case where said duration time is longer than said preset departure time.

In view that a situation of discontinuous view may occur to the user viewing the display when viewing or listening to the content played in the display, according to the present embodiment, where exists a user viewing the display in the target region, an adjustment operation is conducted when the duration time in which exists no user viewing the display in the target region is longer than the preset time, rather than immediately adjusting the image output and/or audio output of the display, so that the adjustment operation is conducted until it is accurately determined that user previously viewing the display has stopped viewing, thus mis-operation is avoided and user experience is improved.

For example, after said control module 13 adjusts the image output and/or the audio output of said display, when said acquisition module 11 detects there exists user who is viewing the display in said target region,

said adjusting unit 132 further configured to recover the image output and/or the audio output of said display to the status before adjustment.

According to the present embodiment, after the image output and/or the audio output of the display is adjusted, when it is detected again a user viewing the display within the target region, the play status of the display can be recovered automatically without the user's manual operation.

For example, when the acquisition module 11 detects there exists user viewing the display in said target region, and when the current user is consistent to the one before adjustment, the image output and/or the audio output of said display is adjusted back to the status before adjustment.

If the current user is not consistent to the one before adjustment, the current user may not be about to viewing the display, such as one just passes by the target region. According to the present embodiment, it is possible to determine the user who has previously viewed the display is back to view the display only when the current user is consistent to the one before adjustment, so as to automatically recover the display to play status, and improve the accuracy of the operation of recovery.

For example, it further comprises:

a recognition module 14 configured to recognize a type of a play program of said display,

wherein, said adjusting unit 132 is configured to adjust the image output and/or the audio output of said display according to said information about view habit and said type of the play program.

According to the present embodiment, it is possible to make different adjustments to different types of the play content.

For example, if the information about view habit of the user is no adjustment to the display after the user leaving the target region, when it is recognized that the type of the play program viewed by the user is a sports program or a news program, the image output of the display may be closed when the user leaves the target region, maintaining the audio output of the display. As for sports program and news program, it is possible to know the played content only by listening to the audio of the broadcaster without watching the image, accordingly, the image output of the display may be closed leaving the audio output of the display, so as to realize energy saving in the premise of satisfying the user's need.

For example, when said acquisition module 11 detects the information of a plurality of users within said target regions, a plurality of user identities are verified according to the information of said plurality of users, and a user identity of the highest priority is determined among the information of said plurality of users;

said query module 12 is to query the information about view habit of the corresponding highest priority according to said user identity of the highest priority;

said control module 13 is to adjust the image output and/or the audio output of said display according to the information about view habit of the highest priority.

When there exists a plurality of users viewing the display at the beginning, such as the determined user identities comprises children, the young and the old, wherein children has the highest priority. When there exists no user viewing the display in the target region, adjustment is made according to the information about view habit of the children, such as to reduce the illuminance of the image displayed by the display and/or reduce the volume of the played audio, so as to realize energy saving meanwhile ensuring the children's needs.

For example, the acquisition module 11 is configured to determine whether there exists a user in said target region.

If no user exists, it determines there exists no user viewing the display in said target region.

If a user exists, it decides whether the face of the user is towards the display, if the face of the user is not towards the display, it determines there exists no user viewing the display in said target region, if the face of the user is towards the display, it determines there exists user viewing display in said target region.

It can be determined there exists no user viewing the display within the target region according to different situations, so as to conduct the adjustment operation more accurately.

For example, the control module 13 is to adjust the image output and/or the audio output of said display comprising: at least one of closing the image output, closing the audio output, reducing an image luminance, and reducing an audio volume.

Wherein, closing the image output can be realized by adjusting backlight source without turning off the image transmission signal so as to recover the display quickly.

For example, it further comprises: a setting module 15 configured to set the information about view habit according to the received instruction;

a statistic module 16 configured to calculate the duration time in which the user does not view the display each time and the type of program viewed by the user and adjust corresponding information about view habit according to a statistic result.

The present invention further provides a display device, comprising the display control system of any one of the above items.

It is noticed that the display device of the present embodiment may be: E-paper, mobile, flat computer, TV, notebook computer, digital camera, navigator and any products or components having display function.

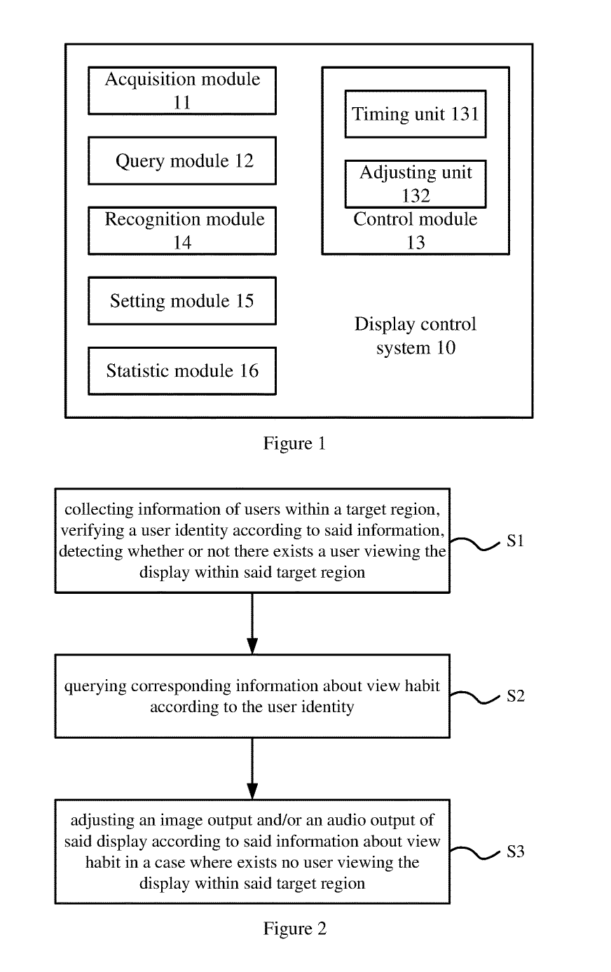

As shown in FIG. 2, the method for display control according to an embodiment of the present invention comprises:

S1, collecting information of users within a target region, verifying a user identity according to said information, detecting whether or not there exists a user viewing the display within said target region;

S2, querying corresponding information about view habit according to the user identity;

S3, adjusting an image output and/or an audio output of said display according to said information about view habit in a case where exists no user viewing the display within said target region.

For example, said information about view habit comprises a preset departure time and a preset play manner, and adjusting an image output and/or audio output of said display according to said information about view habit comprises:

recording a duration time in which there exists no user viewing the display within the target region;

adjusting the image output and/or the audio output of said display according to said preset play manner in a case where said duration time is longer than said preset departure time.

For example, after adjusting the image output and/or the audio output of said display, when it is detected that there exists user viewing the display in said target region, recovering the image output and/or the audio output of said display to the status before adjustment.

For example, when it is detected that there exists user viewing the display in said target region, and when the current user is consistent to the one before adjustment, adjusting the image output and/or the audio output of said display back to the status before adjustment.

For example, it further comprises: recognizing the type of the play program of said display, and adjusting the image output and/or the audio output of said display according to said information about view habit comprises:

Adjusting the image output and/or the audio output of said display according to said information about view habit and said type of the play program.

For example, when acquisition module collects the information of a plurality of users within said target regions, verifying user identities according to information comprises:

verifying the plurality of user identities according to the information of said plurality of users, and determining a user identity of the highest priority among the information of said plurality of users;

querying the information about view habit of the corresponding highest priority according to said user identity of the highest priority by said query module;

adjusting the image output and/or the audio output of said display according to the information about view habit of the highest priority by said control module.

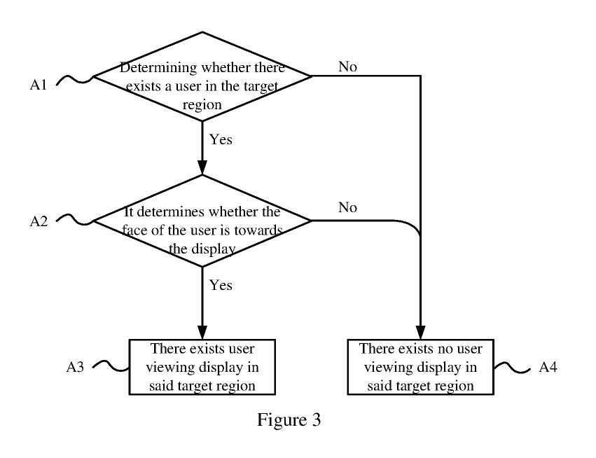

As shown in FIG. 3, determining whether there exists a user viewing the display in said target region comprises:

A1, determining whether there exists a user in the target region,

A4, if no user exists, it decides there exists no user viewing display in said target region,

A2, if a user exists, it determines whether the face of the user is towards the display,

A4, if the face of the user is not towards the display, it determines there exists no user viewing the display in said target region,

A3, if the face of the user is towards the display, it determines there exists user viewing display in said target region.

For example, adjusting the image output and/or the audio output of said display comprising: at least one of closing the image output, closing the audio output, reducing an image luminance, and reducing an audio volume.

For example, it further comprises:

setting the information about view habit according to an received instruction;

calculating a duration time in which the user does not view the display each time and the type of program viewed by the user and adjusting corresponding information about view habit according to a statistic result.

The present technical solution is illustrated in details above with reference to the drawings, once no user is detected viewing the display, the image output is stopped without adjustment according to the view habit of different users. By the present technical solution, it is possible to control the display with only the audio and image output, or only adjusts the audio output, or both adjusts the image output and the audio output according to the user of different identities in a case where exists no user viewing the display within the target region, as compared to stop outputting image once no user is detected viewing the display in the prior art, the present invention not only can reduce the power consumption of the display but also adapt the control of the display to the view habit of the user, and advantageously ensure the view experience of the user.

In the present invention, unless otherwise clearly defined, the term “a plurality of” refers to two or more.

The foregoing is only preferred embodiments of the present invention but not to limit the invention to those skilled in the art, the present invention may have various changes and variations. Any modification within the spirit and principles of the present invention, made, equivalent replacement, or improvement should be included within the scope of the present invention.

The present application claims priority to Chinese Patent Application No. 201510490627.4 filed on Aug. 11, 2015, the contents of which are hereby incorporated by reference in its entirety as part of the disclosure of the present application.

What is claimed is:

1. A display control system, comprising:
an acquisition module configured to collect information of users within a target region, verify user identity according to said information, and also to detect whether exists a user viewing the display within said target region;
a query module configured to query corresponding information about view habit according to the user identity;
a control module configured to adjust an image output and/or an audio output of said display according to said information about view habit in a case where exists no user viewing the display within said target region.

2. The display control system according to claim 1, wherein, said information about view habit comprises a preset departure time and a preset play manner, and said control module comprises:
a timing unit configured to record a duration time in which exists no user viewing the display within the target region;
an adjusting unit configured to adjust the image output and/or the audio output of said display according to said preset play manner in a case where said duration time is longer than said preset departure time.

3. The display control system according to claim 1, wherein, after said control module adjusts the image output and/or the audio output of said display, when said acquisition module detects there exists user viewing the display in said target region,
said adjusting unit further configured to recover the image output and/or the audio output of said display to the status before adjustment.

4. The display control system according to claim 3, wherein, when said acquisition module detects there exists user viewing the display in said target region, and when the current user is consistent to the one before adjustment, the image output and/or the audio output of said display is adjusted back to the status before adjustment.

5. The display control system according to claim 1, further comprising:
a recognition module configured to recognize a type of a play program of said display,
wherein, said adjusting unit is configured to adjust the image output and/or the audio output of said display according to said information about view habit and said type of the play program.

6. The display control system according to claim 5, wherein, when said acquisition module collects the information of a plurality of users within said target regions, a plurality of user identities are verified according to the information of said plurality of users, and a user identity of the highest priority is determined among said plurality of user identities;
said query module is configured to query the information about view habit of the corresponding highest priority according to said user identity of the highest priority;
said control module is configured to adjust the image output and/or the audio output of said display according to the information about view habit of the highest priority.

7. The display control system according to claim 5, wherein, said acquisition unit is configured to determine whether there exists a user in said target region,
if no user exists, it determines there exists no user viewing the display in said target region,
if a user exists, it decides whether the face of the user is towards the display,
if the face of the user is not towards the display, it determines there exists no user viewing the display in said target region,
if the face of the user is towards the display, it determines there exists user viewing the display in said target region.

8. The display control system according to claim 5, wherein, said control module configured to adjust the image output and/or the audio output of said display comprising: at least one of closing the image output, closing the audio output, reducing an image luminance, and reducing an audio volume.

9. The display control system according to claim 5, further comprising:
a setting module configured to set the information about view habit according to the received instruction;
a statistic module configured to calculate the duration time in which the user does not view the display each time and the type of program viewed by the user and adjust corresponding information about view habit according to a statistic result.

10. A display device, comprising the display control system of claim 1.

11. A method for display control, comprising:
collecting information of users within a target region, verifying a user identity according to said information, detecting whether or not there exists a user viewing the display within said target region;
querying corresponding information about view habit according to the user identity;
adjusting an image output and/or an audio output of said display according to said information about view habit in a case where exists no user viewing the display within said target region.

12. The method for display control according to claim 11, wherein, said information about view habit comprises a preset departure time and a preset play manner, and adjusting the image output and/or the audio output of said display according to said information about view habit comprises:
recording a duration time in which there exists no user viewing the display within the target region;
adjusting the image output and/or the audio output of said display according to said preset play manner in a case where said duration time is longer than said preset departure time.

13. The method for display control according to claim 11, wherein, after adjusting the image output and/or the audio output of said display by said control module, when it is detected that there exists user viewing the display in said target region, recovering the image output and/or the audio output of said display to the status before adjustment.

14. The method for display control according to claim 13, wherein, when it is detected that there exists user viewing the display in said target region, and when the current user is consistent to the one before adjustment, adjusting the image output and/or the audio output of said display back to the status before adjustment.

15. The method for display control according to claim 11, further comprising:
recognizing the type of the play program of said display, and adjusting the image output and/or the audio output of said display according to said information about view habit comprises:
adjusting the image output and/or the audio output of said display according to said information about view habit and said type of the play program.

16. The method for display control according to claim 15, wherein, when said acquisition module collects the information of a plurality of users within said target regions, verifying a plurality of user identities according to said information comprising:
verifying the plurality of user identities according to the information of said plurality of users, determining a user identity of the highest priority among the information of said plurality of users;
querying the information about view habit of the corresponding highest priority according to said user identity of the highest priority by said query module;
adjusting the image output and/or the audio output of said display according to the information about view habit of the highest priority by said control module.

17. The method for display control according to claim 15, wherein, determining whether there exists a user viewing the display in said target region comprises:
determining whether there exists a user in said target region;
if no user exists, it decides there exists no user viewing the display in said target region,
if a user exists, it determines whether the face of the user is towards the display,
if the face of the user is not towards the display, it determines there exists no user viewing the display in said target region,
if the face of the user is towards the display, it determines there exists user viewing the display in said target region.

18. The method for display control according to claim 15, wherein, adjusting the image output and/or the audio output of said display comprising: at least one of closing the image output, closing the audio output, reducing an image luminance, and reducing an audio volume.

19. The method for display control according to claim 15, further comprising:
setting the information about view habit according to an received instruction;
calculating a duration time in which the user does not view the display each time and the type of program viewed by the user and adjusting corresponding information about view habit according to a statistic result.
